(19) United States
(12) Patent Application Publication
(10) Pub. No.: US 2021/0326980 A1
(43) Pub. Date: Oct. 21, 2021

(54) SYSTEMS AND METHODS FOR VERIFICATION OF INCOME AND ASSETS

(71) Applicant: Finicity Corporation, Murray, UT (US)

(72) Inventors: Nicholas A. Thomas, Orem, UT (US); Steven B. Smith, Murray, UT (US); Charles Matthew Whitmer, Murray, UT (US)

(73) Assignee: Finicity Corporation, Murray, UT (US)

(21) Appl. No.: 17/363,766

(22) Filed: Jun. 30, 2021

Related U.S. Application Data
(63) Continuation of application No. 15/878,194, filed on Jan. 23, 2018.
(60) Provisional application No. 62/452,926, filed on Jan. 31, 2017.

(51) Int. Cl. G06Q 40/02

(52) U.S. Cl. CPC G06Q 40/025

(57) ABSTRACT

A method for providing an accurate evaluation of a borrower's creditworthiness includes using a network-connected aggregation server to aggregate records of a plurality of financial transactions from one or more network-connected financial institution servers, wherein each record of a financial transaction comprises a unique identifier associated with its transaction and using the records of the plurality of financial transactions to determine estimated financial information of the borrower. The estimated financial information of the borrower may include an estimated cash flow stream of the borrower, an estimated income stream of the borrower, an estimated trade line of the borrower, or estimated assets of the borrower. The method may also include using the estimated financial information of the borrower to create an evaluation of the borrower's creditworthiness and providing the evaluation of the borrower's creditworthiness to a recipient that is considering whether to extend a loan to the borrower.

### CROSS-REFERENCED APPLICATIONS

This application claims the benefit of priority from to United States Provisional Patent Application No. 62/452,926 which was filed Jan. 31, 2017.

### BACKGROUND OF THE INVENTION

### 1. Field of the Invention

The present invention relates to the use of aggregated financial information to provide verification of income and/or assets and more particularly to use of aggregated and verified financial information to provide rapid and accurate verification of income and/or assets in the context of loan approval.

### 2. Background and Related Art

Traditionally, in the credit industry, it is common for lenders to use a variety of methods to verify borrowers' creditworthiness prior to issuing new credit. This is particularly true in the area of mortgage lending given the often large sums involved in mortgage lending. One of the primary ways in which lenders ascertain and/or verify borrowers' creditworthiness is by way of obtaining FICO (originally Fair, Isaac and Company) scores that are calculated based on a variety of credit data in the borrowers' credit reports maintained by the major credit reporting agencies (e.g., Experian, Equifax, and/or TransUnion). FICO scores are calculated based on factors such as amounts owed, payment history, new credit, length of credit history, and mix of credit. FICO scores have been used by lenders such as Fannie Mae and Freddie Mac for a number of years.

While FICO scores are generally helpful in evaluating borrowers' creditworthiness, difficulties remain in evaluating creditworthiness solely using FICO scores or equivalent measurements. For example, different credit agencies may have different information regarding borrowers' credit, and may provide different FICO scores. Similarly, any FICO score is, by necessity, at best only an approximation of borrowers' creditworthiness. The difficulties are such that as many as approximately 30% of borrowers that are approved using FICO scores eventually default on the loans for which they were approved. In addition to the borrowers for whom the FICO score represents an overestimation of creditworthiness (leading to an increased risk of default), it is recognized that for some borrowers, the FICO score represents an underestimation of creditworthiness. For this reason, many lenders allow borrowers to demonstrate their creditworthiness through one or more alternate paths when the lenders would be unwilling to extend credit based on the FICO score alone.

Another problem exists for borrowers and lenders in such situations, however. Generally, the alternate methods by which a borrower can demonstrate creditworthiness are burdensome on both the borrower and the lender. The borrower is burdened in that the borrower typically needs to accumulate and provide significant evidence of creditworthiness (in the form of evidence of income, evidence of assets, evidence of payment history, evidence of other debts, etc.). Similarly, the potential creditor is burdened in evaluating all of this evidence and ensuring that all applicable evidence and information has been properly disclosed.

Still other difficulties are encountered by would-be borrowers that use less credit than average, relying instead on cash, cash instruments such as checks, and debit cards. It is a long-recognized problem in the lending industry that such individuals do not establish a credit history of the type traditionally captured and evaluated by traditional credit reports and credit scores, making it more difficult for lenders to evaluate the creditworthiness of such would-be borrowers.

Currently, despite significant advancements in computer systems and in the information that is potentially available to assist lenders in evaluating borrowers' creditworthiness, significant barriers remain to improving creditors' ability to evaluate their borrowers' creditworthiness. The difficulties are evidenced by creditors continuing to refuse to extend credit to borrowers who would be able to satisfy their loan obligations, as well as by the ongoing high rate of default on loans that are extended from lenders to borrowers. The difficulties are further evidenced by the procedures implemented under the Fair Credit Reporting Act (FCRA), which allows consumers to dispute or correct inaccurate information contained in their credit reports.

### BRIEF SUMMARY OF THE INVENTION

Implementation of the invention provides systems, methods, and computer program products for implementing methods for providing an accurate evaluation of borrowers' creditworthiness.

According to implementations of the invention, a method for providing an accurate evaluation of a borrower's creditworthiness includes using a network-connected aggregation server to aggregate records of a plurality of financial transactions from one or more network-connected financial institution servers, wherein each record of a financial transaction comprises a unique identifier associated with its transaction and using the records of the plurality of financial transactions to determine estimated financial information of the borrower. The estimated financial information of the borrower may include an estimated cash flow stream of the borrower, an estimated income stream of the borrower, an estimated trade line of the borrower, or estimated assets of the borrower. The method may also include using the estimated financial information of the borrower to create an evaluation of the borrower's creditworthiness and providing the evaluation of the borrower's creditworthiness to a recipient that is considering whether to extend a loan to the borrower.

In some instances, the evaluation of the borrower's creditworthiness may be audited by confirming the plurality of financial transactions using their unique identifiers. Where trade line information is used, the trade line of the borrower may include financial information such as rent payment history, mortgage payment history, or utility payment history. Such information may be used as an alternate evaluation tool to permit approval of a credit application where other traditional information does not support the credit application or show the borrower's creditworthiness.

The unique identifier may include a financial institution transaction identifier (FITID) established according to the open financial exchange (OFX) specification.

The aggregation server may be used to aggregate records of a plurality of financial transactions from a plurality of financial institution servers representing a plurality of financial accounts associated with the borrower. The step of providing the evaluation of the borrower's creditworthiness may involve transmitting the evaluation over a network to a recipient computer system such as a lender computer system, an underwriting computer system, a loan investment computer system, a loan guarantor computer system, or a loan originator computer system.

The aggregation server may aggregate the records of the plurality of financial transactions at or near a time at which a request for the evaluation of the borrower's creditworthiness is received by a verification service. Additionally or alternatively, the aggregation server aggregates the records of the plurality of financial transactions on a periodic, or a continual basis. Thus, when a request for the evaluation of the borrower's creditworthiness is received by a verification service, the evaluation of the borrower's creditworthiness is prepared using (at least in part) previously obtained and stored records of at least a portion of the plurality of financial transactions.

The method may include a step of receiving a request for the evaluation of the borrower's creditworthiness. Due to the efficiencies provided in accordance with implementations of the invention, the evaluation of the borrower's creditworthiness may be provided to the recipient within a day of the receipt of the request, or even sooner.

According to further implementations of the invention, a method for providing an evaluation of a borrower's creditworthiness includes aggregating records of a plurality of financial transactions over a computer network from one or more network-connected financial institution servers, wherein each record of a financial transaction comprises a unique identifier associated with its transaction and using the records of the plurality of financial transactions to determine estimated financial information of the borrower. The method may also include using the estimated financial information of the borrower to create an evaluation of the borrower's creditworthiness and providing the evaluation of the borrower's creditworthiness to a recipient that is considering whether to extend a loan to the borrower. The estimated financial information of the borrower may include information such as an estimated cash flow stream of the borrower, an estimated income stream of the borrower, an estimated trade line of the borrower, or estimated assets of the borrower.

According to additional implementations of the invention, systems are provided to implement the methods discussed herein, including computer systems, networked computer systems, and server systems. According to additional implementations of the invention, computer program products are provided to cause computer systems such as those discussed herein to implement the methods discussed herein.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a representative computer system for use in accordance with embodiments of the invention;

FIG. 2 shows a representative networked computer system for use in accordance with embodiments of the invention;

FIG. 3 shows a representative networked computer environment used in conjunction with embodiments of the invention; and

FIG. 4 shows a flow chart in accordance with embodiments of the invention.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention provide systems, methods, and computer program products for implementing methods for providing an accurate evaluation of borrowers' creditworthiness.

According to embodiments of the invention, a method for providing an accurate evaluation of a borrower's creditworthiness includes using a network-connected aggregation server to aggregate records of a plurality of financial transactions from one or more network-connected financial institution servers, wherein each record of a financial transaction comprises a unique identifier associated with its transaction and using the records of the plurality of financial transactions to determine estimated financial information of the borrower. The estimated financial information of the borrower may include an estimated cash flow stream of the borrower, an estimated income stream of the borrower, an estimated trade line of the borrower, or estimated assets of the borrower. The method may also include using the estimated financial information of the borrower to create an evaluation of the borrower's creditworthiness and providing the evaluation of the borrower's creditworthiness to a recipient that is considering whether to extend a loan to the borrower.

In some instances, the evaluation of the borrower's creditworthiness may be audited by confirming the plurality of financial transactions using their unique identifiers. Where trade line information is used, the trade line of the borrower may include financial information such as rent payment history, mortgage payment history, or utility payment history. Such information may be used as an alternate evaluation tool to permit approval of a credit application where other traditional information does not support the credit application or show the borrower's creditworthiness.

The unique identifier may include a financial institution transaction identifier (FITID) established according to the open financial exchange (OFX) specification. By attaching the FITID identifier to each transaction, duplicates and fraudulent entries may be removed before the algorithm calculates credit worth. The aggregation server may be used to aggregate records of a plurality of financial transactions from a plurality of financial institution servers representing a plurality of financial accounts associated with the borrower. These verified transactions are then processed by an algorithm that converts the transaction information into an estimate of assets or income. The algorithm considers the spending habits of the average person having a set income or having a set amount of assets. The spending habits are determined by aggregating transactions processed by the applicant's financial institutions for example, credit cards, savings, checking, etc. As each of these transactions has a unique identifier, the transactions may be audited to remove duplicate transactions and to verify the authenticity of each transaction as originating at a financial institution.

The step of providing the evaluation of the borrower's creditworthiness may involve transmitting the evaluation produced by the algorithms over a network to a recipient computer system such as a lender computer system, an underwriting computer system, a loan investment computer system, a loan guarantor computer system, or a loan originator computer system.

The aggregation server may aggregate the records of the plurality of financial transactions at or near a time at which a request for the evaluation of the borrower's creditworthiness is received by a verification service. Additionally or alternatively, the aggregation server aggregates the records of the plurality of financial transactions on a periodic or a continual basis. Thus, when a request for the evaluation of the borrower's creditworthiness is received by a verification service, the evaluation of the borrower's creditworthiness may be prepared using (at least in part) previously obtained and stored records of at least a portion of the plurality of financial transactions or all recent records.

The method may include a step of receiving a request for the evaluation of the borrower's creditworthiness. Due to the efficiencies provided in accordance with embodiments of the invention, the evaluation of the borrower's creditworthiness may be provided to the recipient within a day of the receipt of the request, or even sooner. Since no evidentiary documents are required to prove income or assets, a much quicker evaluation of creditworthiness can be provided.

According to further embodiments of the invention, a method for providing an evaluation of a borrower's creditworthiness includes aggregating records of a plurality of financial transactions over a computer network from one or more network-connected financial institution servers, wherein each record of a financial transaction comprises a unique identifier associated with its transaction and using the records of the plurality of financial transactions to determine estimated financial information of the borrower. The method may also include using the estimated financial information of the borrower to create an evaluation of the borrower's creditworthiness and providing the evaluation of the borrower's creditworthiness to a recipient that is considering whether to extend a loan to the borrower. The estimated financial information of the borrower may include information such as an estimated cash flow stream of the borrower, an estimated income stream of the borrower, an estimated trade line of the borrower, or estimated assets of the borrower.

According to additional embodiments of the invention, systems are provided to implement the methods discussed herein, including computer systems, networked computer systems, and server systems. According to still further embodiments of the invention, computer program products are provided to cause computer systems such as those discussed herein to implement the methods discussed herein.

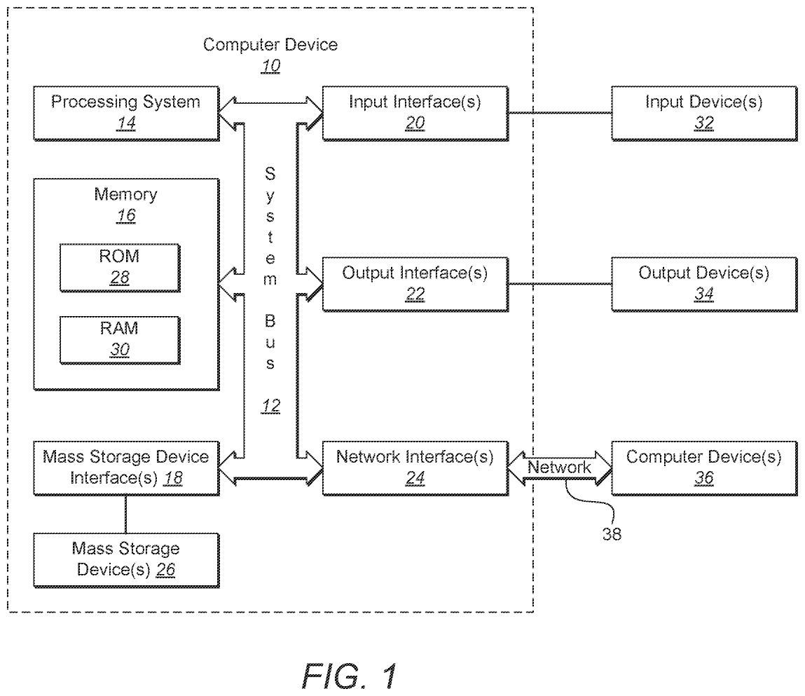

As embodiments of the invention are adapted for implementation in conjunction with various computer systems, FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

With reference to FIG. 1, a representative system for implementing embodiments of the invention includes computer device 10, which may be a general-purpose or special-purpose computer or any of a variety of consumer electronic devices. For example, computer device 10 may be a personal computer, a notebook or laptop computer, a netbook, a personal digital assistant (“PDA”) or other hand-held device, a smart phone, a tablet computer, a workstation, a minicomputer, a mainframe, a supercomputer, a multi-processor system, a network computer, a processor-based consumer electronic device, a computer device integrated into another device or vehicle, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer-readable media, such as on memory 16, a magnetic hard disk, a removable magnetic disk, a magnetic cassette, an optical disk, or from a communication connection, which may also be viewed as a computer-readable medium.

Memory 16 includes one or more computer-readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer-readable medium. Mass storage devices 26 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

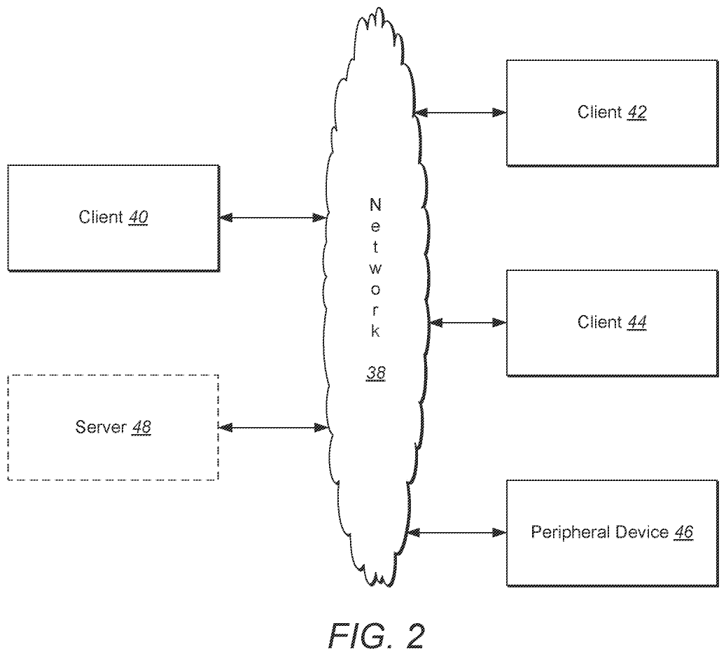

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices (illustrated as multifunctional peripheral (MFP) MFP 46) across network 38. While FIG. 2 illustrates an embodiment that includes a client 40, two additional clients, client 42 and client 44, one peripheral device, MFP 46, and optionally a server 48 connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

Similarly, embodiments of the invention embrace cloud-based architectures where one or more computer functions are performed by remote computer systems and devices at the request of a local computer device. Thus, returning to FIG. 2, the client 40 may be a computer device having a limited set of hardware and/or software resources. Because the client 40 is connected to the network 38, it may be able to access hardware and/or software resources provided across the network 38 by other computer devices and resources, such as client 42, client 44, server 48, or any other resources. The client 40 may access these resources through an access program, such as a web browser, and the results of any computer functions or resources may be delivered through the access program to the user of the client 40. In such configurations, the client 40 may be any type of computer device or electronic device discussed above or known to the world of cloud computing, including traditional desktop and laptop computers, smart phones and other smart devices, tablet computers, or any other device able to provide access to remote computing resources through an access program such as a browser.

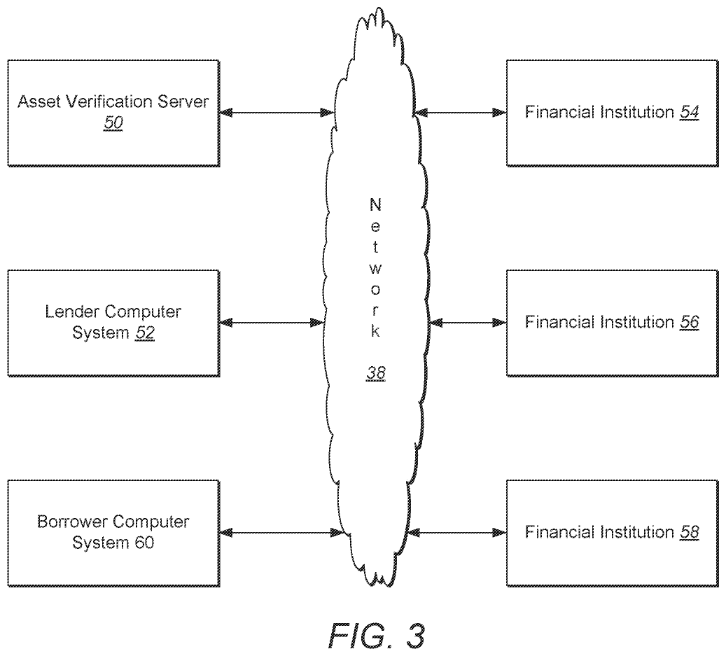

FIG. 3 illustrates a specific illustrative networked computer embodiment in accordance with certain embodiments of computer systems in which embodiments of the invention may be implemented or practiced. In FIG. 3, the network 38 (e.g., the Internet) connects a variety of computer systems and servers together, including an asset verification server 50. The asset verification server is illustrated as a single server system, but it will be appreciated that the asset verification server 50 may actually be implemented as a variety of computer systems and servers functioning as one functional unit, and as used herein, the term “server” is intended to embrace a variety of computer systems functioning a single server unit, including distributed computer systems functioning as a single server unit.

Also connected to the network is a lender computer system 52. The lender computer system 52 may be any computer system from a personal computing device such as a mobile phone, laptop, desktop, or the like, up to a lender server system such as that of the asset verification server 50. The lender computer system 52 is typically used by a lender in conjunction with processing loan applications received from a borrower, in sending requests to the asset verification provider to verify borrowers' creditworthiness, and in receiving evaluations or reports of borrowers' creditworthiness from the asset verification provider.

FIG. 3 also illustrates three financial institutions being connected to the network 38, namely financial institution 54, financial institution 56, and financial institution 58. While three financial institutions are illustrated in FIG. 3, it should be appreciated that embodiments of the invention may be practiced in conjunction with any number of financial institutions, from one up to as many financial institutions as may exist at any one point in time. Each financial institution operates one or more computer systems that are operatively or communicatively connected to the network 38 and that can provide information about the financial institutions' accounts and transactions to the asset verification server 50 over the network 38. The financial institutions maintain information regarding their customers' financial accounts and transactions.

Financial institutions generally provide multiple mechanisms by which their customers and other third parties authorized by their customers can access information maintained by the financial institutions. Generally, when a customer wishes to allow a third party (e.g. a financial services provider, such as a provider of a budgeting application) access to the customer's financial information, the customer provides the third party with their access information (e.g. user name and password), and the third party uses this information to access the customer's account information. The third party can use a variety of mechanisms made available by the financial institutions. For example, they can scrape the information from HTML pages provided by the financial institutions, they can use some sort of direct file download, or they can use a mobile application program interface (API).

One problem with using many of these methods is that such methods provide information that is subject to error and to duplication of data. As a result, financial data obtained using such methods lends itself to inaccuracies, and is generally suitable only for applications where high-level accuracy is not needed. In contrast, for electronically aggregated financial data to be used by financial entities in making important financial decisions such as lending decisions, the data obtained must be accurate, verifiable and auditable. The only such data currently available is through direct APIs provided by or for the financial institutions that include unique identifiers associated with each transaction. By way of example, the open financial exchange (OFX) specification defines the association of permanent unique financial institution transaction identifiers (FITID) with each cleared transaction. The use of the unique FITIDs or similar identifiers allows for deduplication of data, ensures that transactions have cleared, and provides unique opportunities to ensure that the data used is of the highest quality.

Embodiments of the invention thus use only data sources that provide a unique identifier such as the FITID. Thus, when the evaluation is made of the borrowers' creditworthiness, the recipients of such evaluations can be confident that the underlying data is accurate, and are able to audit and confirm all data used. While direct APIs may be used to provide access to this data at the financial institutions, any other mechanism to access data from the financial institutions that includes unique identifiers may also be used. Such information is generally accessed over the network 38, which may include general networks such as the Internet and/or special-purpose networks not generally available to the public.

FIG. 3 also illustrates a borrower computer system 60. It is increasingly common for borrowers to use a computer system connected to the Internet or another network to initiate a loan application with a lender. While FIG. 3 thus illustrates the borrower computer system 60, it should be understood that the lender can receive a loan application using any method, including in-person applications, mailed-in applications, or any other mechanism for receiving a loan application.

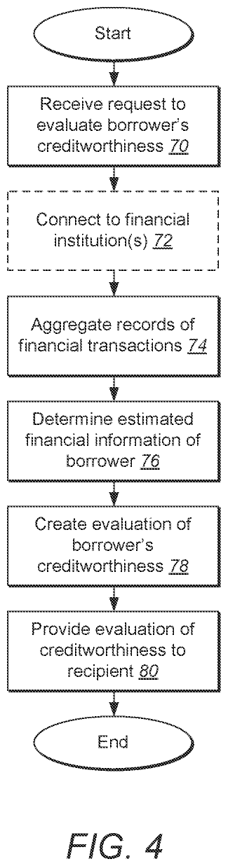

According to implementations of the invention, the borrower begins a loan application with a lender according to any desired process. Once the loan application is complete or sufficiently complete for the lender or for a party affiliated with the lender to be able to request an evaluation of the would-be borrower's creditworthiness, a process may be implemented as illustrated in FIG. 4. At step 70, the lender requests an evaluation of the borrower's creditworthiness. This request may be conveyed to the creditworthiness service provider using any desirable method (e.g., phone, mail, computer transmission, etc.), but it is anticipated that such requests will generally be transmitted electronically, e.g. over the network 38, to take advantage of the time savings provided by embodiments of the invention.

Generally, the request will be accompanied by authorization from the would-be borrower to access financial information maintained about the borrower at one or more financial institutions, along with sufficient information to permit the evaluation service provider to access (e.g., electronically) the borrower's information maintained at the financial institution or institutions. Alternatively, as part of the loan application process, the borrower may be requested to connect to the service provider to provide the necessary information and authorization. Such step is not depicted in FIG. 4. As yet another alternative, the service provider may be provider of other financial services, such as budgeting and financial tracking services, and the would-be borrower might already have an account with the service provider, whereby the service provider already has sufficient information or access to the borrower's financial information maintained at the financial institutions.

In any event, when the request to evaluate creditworthiness is received, the system (e.g., the asset verification system associated with the asset verification server 50) collects information regarding the borrower's financial transactions. This may be done in one or more of several fashions. In one example, such as where the borrower already uses the service provider for other services, the system already maintains information regarding the borrower's financial accounts and transactions, and the system either uses such information or conducts an update of the information. As another alternative, the system connects to any applicable financial institutions and obtains the information, including the unique transactions identifiers, using applicable methods (e.g., using the direct APIs provided by or for the financial institutions). This latter method is depicted in FIG. 4 as optional step 72 of connecting to the financial institution or institutions (if a connection is not already established), and as step 74 of aggregating records of the borrower's financial transactions.

Once the information about transactions is obtained, it is used at step 76 to determine estimated financial information of the borrower. While the word “estimated” is used to describe the determined information, it should be appreciated that the information determined may be of significantly higher reliability than the information used by traditional credit reports and credit scores. Specifically, the information relied upon may include transactions on traditional credit accounts, but also transactions on other types of accounts such as savings accounts, checking accounts, money market accounts, deposit accounts including certificate of deposit accounts, and any other account maintained by the financial institutions.

The step of determining estimated financial information of the borrower may include estimating any information that will facilitate evaluating creditworthiness. For example, the system may estimate a cash flow stream of the borrower, an income stream of the borrower, available assets of the borrower, or any other applicable financial information. For example, it is traditional for borrowers who do not have sufficient credit history using traditional methods to establish their creditworthiness by demonstrating one or more of their trade lines relevant to the lending decision. Examples of such trade lines include rent and mortgage payments, as well as utility payments. Embodiments of the invention as disclosed herein provide simple access to such information, such as by tracking the payee for checks or direct payments. Thus, the system may provide estimated or actual trade line information for evaluation.

Once the financial information of the borrower is accumulated using the aggregation engine, one or more algorithms may be used to evaluate the borrower's creditworthiness at step 78. As discussed, the evaluation of the borrower's creditworthiness so created may generally be accurate enough to provide a very rapid estimate of creditworthiness that is accurate enough to satisfy the lender. Furthermore, as discussed above, the entire system is fully auditable, which provides the legitimacy required by a lender. At step 80, the evaluation of the borrower's creditworthiness is provided back to the lender (or other party affiliated with the lender), where it can be used in the decision making process used by the lender.

Because the system is highly automated and relies on verifiable data, embodiments of the system are able to provide accurate evaluations of creditworthiness much more rapidly than is possible using current systems. It is not uncommon currently for creditworthiness evaluations to take days or weeks. In contrast, using embodiments of the invention it is possible to provide same-day or next-day evaluations of creditworthiness without sacrificing accuracy of such evaluations. Lenders and borrowers both will benefit from the timeliness advantages provided by embodiments of the invention.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed is:

1. A server system comprising:
a network interface;
a processor coupled in communication with the network interface; and
computer-readable storage media having computer-executable instructions stored thereon, wherein when executed by the processor, the computer-executable instructions cause the processor to:
receive, from a lender computing system via the network interface, an electronic request for a creditworthiness evaluation of a borrower;
establish an electronic connection to a financial institution computing system via the network interface, the financial institution computing system having a financial account of the borrower stored thereon, the financial account comprising a plurality of financial transaction records, each financial transaction record including a unique financial institution transaction identifier (FITID);
aggregate the plurality of financial transaction records;
remove duplicate ones of the plurality of financial transaction records based on FITID to generate deduplicated financial transaction records;
determine estimated financial information of the borrower using the deduplicated financial transaction records; and
generate the creditworthiness evaluation of the borrower based on the estimated financial information.

2. The server in accordance with claim 1, wherein the request for a creditworthiness evaluation is associated with a borrower,
the request for a creditworthiness evaluation including an electronic authorization from the borrower,
the electronic authorization including electronic access information corresponding to a financial account of the borrower.

3. The server in accordance with claim 1 further comprising the computer-executable instructions causing the processor to:
transmit an authorization request to a borrower computing system, the authorization request including a request for electronic access information corresponding to a financial account of the borrower; and
receive an electronic authorization from the borrower computing system, the electronic authorization including the electronic access information.

4. The server in accordance with claim 1,
the operation of determining estimated financial information of the borrower comprises the computer-executable instructions causing the processor to estimate one or more of the following: a cash flow stream, an income stream, trade line information, and available assets.

5. The server in accordance with claim 4, wherein the trade line information comprises one or more of the following: rent payment history, mortgage payment history, and utility payment history.

6. The server in accordance with claim 1,
the operation of aggregating the plurality of financial transaction records comprises the computer-executable instructions causing the processor to perform one or more of the following operations: scrape the plurality of financial transaction records from HTML, pages provided by the financial institution computing system, directly download the plurality of financial transaction records as one or more data files, and collect the plurality of financial transaction records through one or more application programming interfaces (APIs) provided by the financial institution computing system.

7. The server in accordance with claim 1 further comprising the computer-executable instructions causing the processor to transmit the creditworthiness evaluation of the borrower to the lender computing system.

8. A method comprising:
receiving, from a lender computing system via a network interface, an electronic request for a creditworthiness evaluation of a borrower;
establishing an electronic connection to a financial institution computing system via the network interface, the financial institution computing system having a financial account of the borrower stored thereon, the financial account comprising a plurality of financial transaction records, each financial transaction record including a unique financial institution transaction identifier (FITID);
aggregating the plurality of financial transaction records;
removing duplicate ones of the plurality of financial transaction records based on FITID to generate deduplicated financial transaction records;
determining estimated financial information of the borrower using the deduplicated financial transaction records; and
generating the creditworthiness evaluation of the borrower based on the estimated financial information.

9. The method in accordance with claim 8, wherein the request for a creditworthiness evaluation is associated with a borrower,
the request for a creditworthiness evaluation including an electronic authorization from the borrower,
the electronic authorization including electronic access information corresponding to a financial account of the borrower.

10. The method in accordance with claim 8 further comprising:
transmitting an authorization request to a borrower computing system, the authorization request including a request for electronic access information corresponding to a financial account of the borrower; and
receiving an electronic authorization from the borrower computing system, the electronic authorization including the electronic access information.

11. The method in accordance with claim 8,
the operation of determining estimated financial information of the borrower comprising estimating one or more of the following: a cash flow stream, an income stream, trade line information, and available assets.

12. The method in accordance with claim 11, wherein the trade line information comprises one or more of the following: rent payment history, mortgage payment history, and utility payment history.

13. The server in accordance with claim 8,
the operation of aggregating the plurality of financial transaction records comprising one or more of the following: scraping the plurality of financial transaction records from HTML, pages provided by the financial institution computing system, directly downloading the plurality of financial transaction records as one or more data files, and collecting the plurality of financial transaction records through one or more application programming interfaces (APIs) provided by the financial institution computing system.

14. The server in accordance with claim 8 further comprising transmitting the creditworthiness evaluation of the borrower to the lender computing system.

15. One or more non-transitory computer-readable storage media having computer-executable instructions stored thereon, wherein when executed by at least one processor, the computer-executable instructions cause the at least one processor to perform operations comprising:
receiving, from a lender computing system via a network interface, an electronic request for a creditworthiness evaluation of a borrower;
establishing an electronic connection to a financial institution computing system via the network interface, the financial institution computing system having a financial account of the borrower stored thereon, the financial account comprising a plurality of financial transaction records, each financial transaction record including a unique financial institution transaction identifier (FITID);
aggregating the plurality of financial transaction records;
removing duplicate ones of the plurality of financial transaction records based on FITID to generate deduplicated financial transaction records;
determining estimated financial information of the borrower using the deduplicated financial transaction records;
generating the creditworthiness evaluation of the borrower based on the estimated financial information; and
transmitting the creditworthiness evaluation of the borrower to the lender computing system.

16. The non-transitory computer-readable storage media in accordance with claim 15, wherein the request for a creditworthiness evaluation is associated with a borrower,
the request for a creditworthiness evaluation including an electronic authorization from the borrower,
the electronic authorization including electronic access information corresponding to a financial account of the borrower.

17. The non-transitory computer-readable storage media in accordance with claim 15, the computer-executable instructions cause the at least one processor to perform operations further comprising:
transmitting an authorization request to a borrower computing system, the authorization request including a request for electronic access information corresponding to a financial account of the borrower; and
receiving an electronic authorization from the borrower computing system, the electronic authorization including the electronic access information.

18. The non-transitory computer-readable storage media in accordance with claim 15,
the operation of determining estimated financial information of the borrower comprising estimating one or more of the following: a cash flow stream, an income stream, trade line information, and available assets.

19. The non-transitory computer-readable storage media in accordance with claim 18, wherein the trade line information comprises one or more of the following: rent payment history, mortgage payment history, and utility payment history.

20. The non-transitory computer-readable storage media in accordance with claim 15,
the operation of aggregating the plurality of financial transaction records comprising one or more of the following: scraping the plurality of financial transaction records from HTML, pages provided by the financial institution computing system, directly downloading the plurality of financial transaction records as one or more data files, and collecting the plurality of financial transaction records through one or more application programming interfaces (APIs) provided by the financial institution computing system.
